(19) United States
(12) Patent Application Publication
(10) Pub. No.: US 2015/0039395 A1
(43) Pub. Date: Feb. 5, 2015

(54) SALES PROPOSAL MIX AND PRICING OPTIMIZATION

(71) Applicant: Disney Enterprises, Inc., Burbank, CA (US)

(72) Inventors: Thomas W. DENSLOW, III, Winter Garden, FL (US); Haining Yu, Windermere, FL (US); Hai Chu, Orlando, FL (US); Cameron Davies, Winter Garden, FL (US)

(73) Assignee: Disney Enterprises, Inc., Burbank, CA (US)

(21) Appl. No.: 13/956,172

(22) Filed: Jul. 31, 2013

(51) Int. Cl. G06Q 30/00

(52) U.S. Cl. CPC G06Q 30/00
USPC 705/7.35

(57) ABSTRACT

Systems, methods and articles of manufacture to generate sales proposals, by determining, for a customer, a level of preference for each of a plurality of items of inventory, classifying each item of inventory into one of a plurality of categories, determining, for the customer, a price range for each item of inventory, computing a demand for each of a plurality of items of media content, selecting a subset of the items of advertising inventory based on: (i) the demand for each of a plurality of programs, (ii) the level of preference for each of the plurality of items of inventory, and (iii) the classification of each of the plurality of items of inventory, and computing: (i) a total cost for the proposal, and (ii) a cost for each item of inventory in the subset.

### BACKGROUND

1. Field of the Invention

Embodiments disclosed herein relate to the field of computer software. More specifically, embodiments disclosed herein relate to computer software for sales proposal mix and pricing optimization.

2. Description of the Related Art

Product/service provider agreements with buyers can become very complex when many products which may expire are discussed within one deal and when the product and deal level pricing is highly negotiable. With just a small number of products, the number of potential combinations of bundles and prices cannot be thoroughly analyzed by the human brain. The product/service provider may provide an initial proposal or set of proposals to the buyer as a foundation for negotiations between the parties. Current methodologies to support the generation of these proposals are largely based on pre-defined packages or simple adjustments to prior deals. These adjustments typically lack the insight into the complexities of the overall inventory and demand picture to produce incrementally profitable bundling or pricing recommendations. Furthermore, these resulting proposals only output a single recommendation, thus lacking any insight into the unknown behavior or preferences occurring during the negotiation process.

### SUMMARY

Embodiments disclosed herein present techniques to generate sales proposals, by determining, for a customer, a level of preference for each of a plurality of items of inventory, classifying each item of inventory into one of a plurality of categories, determining, for the customer, a price range for each item of inventory, computing a demand for each of a plurality of items of media content, selecting a subset of the items of advertising inventory based on: (i) the demand for each of a plurality of programs, (ii) the level of preference for each of the plurality of items of inventory, and (iii) the classification of each of the plurality of items of inventory, and computing: (i) a total cost for the proposal, and (ii) a cost for each item of inventory in the subset.

Other embodiments include, without limitation, a computer-readable medium that includes instructions that enable a processing unit to implement one or more aspects of the disclosed methods as well as a system having a processor, memory, and application programs configured to implement one or more aspects of the disclosed methods.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIG. 1 illustrates a graphical user interface for sales proposal mix and pricing optimization, according to one embodiment.

FIG. 2 illustrates a summary of proposals generated using sales proposal mix and pricing optimization, according to one embodiment.

FIG. 3 illustrates a proposal generated using sales proposal mix and pricing optimization, according to one embodiment.

FIG. 4 illustrates a method for sales proposal mix and pricing optimization, according to one embodiment.

FIG. 5 illustrates a method to group inventory into categories, according to one embodiment.

FIG. 6 illustrates a method to determine advertiser preference for inventory, according to one embodiment.

FIG. 7 illustrates a method to determine demand for inventory, according to one embodiment.

FIG. 8 illustrates a method to estimate ratings for programs, according to one embodiment.

FIG. 9 illustrates a decision tree to determine customer willingness to pay for inventory, according to one embodiment.

FIG. 10 illustrates a method to create and output proposals, according to one embodiment.

FIG. 11 illustrates a system for sales proposal mix and pricing optimization, according to one embodiment.

FIG. 12 illustrates components of a proposal generator application, according to one embodiment.

### DETAILED DESCRIPTION

Embodiments disclosed herein provide systems, computer-implemented methods, and computer program products to generate sales proposals for many inventory items that may have variable pricing and expiration dates. Generally, internal users associated with the seller may generate the proposal, which may then be provided to a buyer or the buyer's agency for review. To generate a sales proposal, the software computes customer preference and willingness to pay for a bundle or grouping of products and generates bundles of products from many possible combinations that are sellable and desirable to the specific target customer. As used in this disclosure, “customer” includes potential customers. The software also places internal value on inventory to support maximized revenue opportunity as well as maximized profit opportunity. The software may also set optimal “list” prices for inventory at a segmented level to reduce the displacement of revenue that occurs by selling inventory to customers when a higher paying customer may still exist. In one embodiment, a sales proposal may include an optimized mix of inventory with line item prices. The result may also include multiple proposals optimized relative to an optimization strategy. Generally, pricing in the proposals may be based on a variety of criteria such as current market conditions for the supplier, market demand for the supplier's inventory, historical transactions, and external conditions in the overall marketplace.

While embodiments disclosed herein are discussed with the media advertising sales industry (including, but not limited to television, video, Internet, print, and radio) as a reference example, the techniques disclosed herein may support other industries. The general setting is a business-to-business transaction in a marketplace where prices are highly negotiable and there are many products that may be perishable and can be packaged together in different ways to create a long list of potential proposals presentable to the buyer. One example of a marketplace includes a cable advertising scatter market, where every sale of commercial inventory as well as the price for the inventory is negotiated. For cable networks having different channels or broadcast mediums (e.g. television, Internet, print, radio), manually building a proposal mix is heavily biased towards the inventory most frequently seen in the past. Inventory in such a setting is highly perishable in that commercial inventory for one day cannot be saved and sold for the next day. Furthermore, the inventory hierarchy in such a setting is highly heterogeneous.

In one embodiment, a multi-node software solution integrates batch science processes, business rules, transaction system interaction, and real-time bundling and pricing optimization. However, embodiments disclosed herein contemplate any number of compute nodes, systems, or applications implementing the described functionality. An initiation node allows users a variety of parameters to optimize a given proposal, including parameters not provided by the user (or previously defined). In one embodiment, such parameters may be inferred through batched historical purchasing behavior analysis. Additionally, the initiation node may also allow users to view and adjust any inferred parameters.

A second node may apply a business strategy by selecting one or many optimization templates used to generate potential proposals. For example, a customer may ask for a “copy” of a proposal from a previous year. In such a case, an optimization template may store business rules and optimization parameters specific to building the plan. As additional templates are selected, the result has more options to identify possible proposals that meets both the seller's and the buyer's needs.

A third node may be a query node that filters a large amount of batch science data to use only the data relevant for a given optimization to ensure speed of response. The query node may be executed for one or many optimization templates selected in the second node. A fourth node may apply an inventory mix optimization for each selected plan template by leveraging the combination of input parameters, inferred (or implied) parameters, batch science data, and the optimization template business rules and parameters. The inventory mix optimization ensures that the most sellable and efficient combination of inventory is used in the proposal, attempting to reserve as much constrained inventory as possible for future negotiations. A fifth node may apply a pricing optimization that ensures final line item pricing, overall proposal pricing, and the resulting inventory mix satisfy customer expectations.

A sixth node may package the results displayed to an end user in a format that allows the recommendations to be modified. The sixth node may also permit the transfer of the results to another transactional system, e.g., via XML output web services.

In one embodiment, the multi-node system may also include an additional query node. If included, the additional query node may interact with a production transactional system to check for real-time availability of inventory. The positioning of this additional query node is flexible and may depend on response times of the system, specifics of valid dates for proposal delivery, and expected demand for both total and product level advertising inventory.

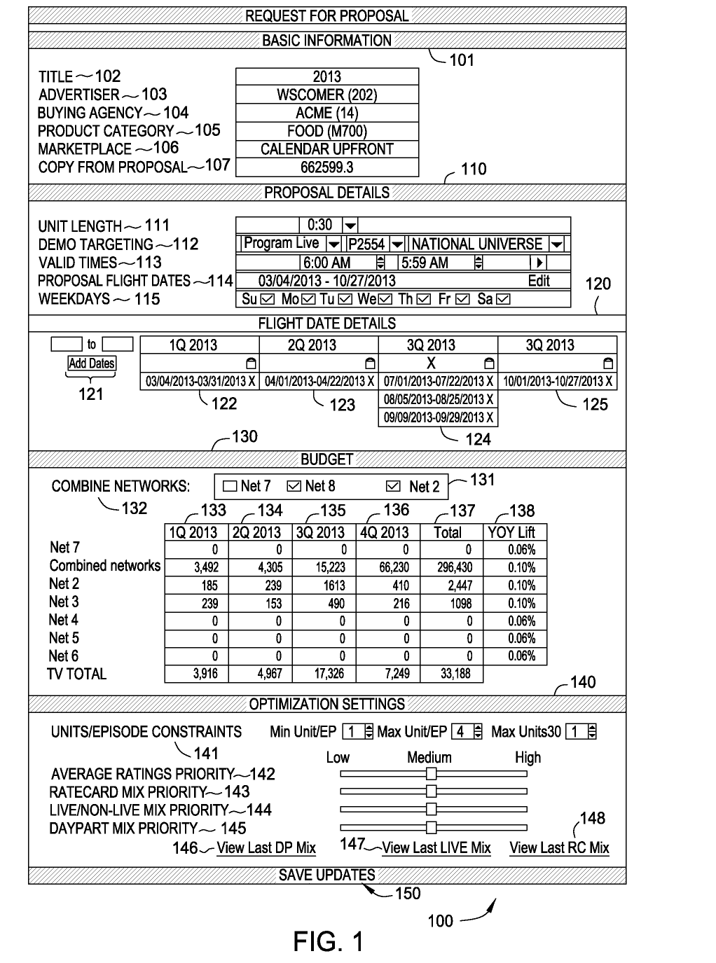

FIG. 1 illustrates a graphical user interface (GUI) 100 for ad sales proposal mix and pricing optimization, according to one embodiment. A user may interact with the GUI 100 to specify parameters for an advertising proposal which includes a subset, or mix, of available inventory. The generated proposal may be optimized in terms of the mix of advertising inventory included in the proposal, such that constrained inventory (inventory that will in all likelihood sell out) is reserved for future deals. Additionally, the pricing of the proposal (as a whole, and on a line-item basis) may be optimized to maximize profit for the network or entity selling the inventory. Although a variety of variables are listed in the GUI 100, users may not provide values for each variable for any number of reasons. For example, the user may not have knowledge of values for some variables, or the user may decline to provide values which are known to be outdated. Values for variables not provided by the user may be inferred by the system prior to generating the proposal.

As shown, the GUI 100 includes basic information interface 101, proposal details interface 110, flight date details interface 120, budget interface 130, and optimization settings interface 140. The basic information interface 101 allows a user to provide a name for the proposal, information on who the buyer is and any agency representation, what industry the buyer is in, the marketplace of the transaction, and a specific historical deal(s) if applicable. In the described embodiment, this includes a proposal title 102, where a user may input a title for the plan, a proposal advertiser 103, used to identify an advertiser/customer, a proposal buying agency 104 identifying an agency representing the proposal advertiser 103, a proposal product category 105 indicating an operating market of the advertiser/customer, a proposal marketplace 106, indicating the timing and relative size of the proposal, and a copy from proposal 107, used to identify a prior proposal that may be used as a foundation for the proposal generated.

The proposal details interface 110 allows a user to provide any targeting information relative to the proposal request, such as the type of customer they want to reach or the general bucket of seller's inventory the user wants included in the proposal. In the depicted embodiment, this includes a unit length 111, defining a unit length for each unit of advertising inventory, such as 30, 60, or 90 seconds. Proposal demo targeting 112 allows a user to specify a ratings measurement stream, a target demographic gender and age range, and a ratings universe of audience. A valid times 113 allows the user to indicate which times of day the advertising units are scheduled, a proposal flight dates 114 allows the user to indicate a date range for the proposal, and a weekdays 115 allows the user to specify which days of the week should be used when selecting inventory for inclusion in the proposal. The flight date details 120 allow a user to specify date ranges during which the advertiser wishes to advertise. For example, an advertiser may only purchase advertisements airing between Mar. 4, 2013 and Mar. 31, 2013 for the first quarter of 2013. As shown, the flight date details 120 includes a date range field 121 for adding date ranges to each of the quarterly ranges 122-125. The quarterly ranges 122-125 specify date ranges during which the customer has a desire to advertise.

A budget section interface 120 includes details about the customer's budget, including what periods they want the budget spend to occur, in what general categories they want the spend to occur, and any pre-defined pricing lifts that has been negotiated or that the seller is targeting for the particular buyer. As an example, a combine networks section 131 allows a user to specify whether individual general inventory categories (e.g. networks) should be combined for the purpose of generating the proposal. In one embodiment, the networks may be combined because the advertiser is indifferent as to which network, of the combined networks, their advertisement airs on. As shown, a table displays budget parameters for each of a plurality of networks 132 on a quarterly basis in fields 133-136. By including different networks, a proposal may be generated which includes advertising units on programs airing on one, all, or several of the networks listed. A total column 137 allows the user to specify the total annual budget, and a year-over-year lift field 138 allows a user to specify an increase relative to the previous year's pricing. The values in fields 133-136 may be user defined, imported from previous proposals, or left blank and inferred by the software.

The optimization settings interface 140 allows a user to influence the proposal results generated by the system. As shown, the optimization settings interface 140 includes a units/episodes constraints field 141, which allows the user to define a minimum and maximum number of units of advertising per episode (a program, or other broadcast), as well as a maximum number of units per half hour. The user may also specify a relative priority for any number of optimization goals, such as an average ratings priority 142, a ratecard (an inventory categorical attribution) mix priority 143, a live/non-live mix priority, and a day-part mix priority. For example, the user may specify that the average ratings priority 142 is low, indicating that the customer does not prioritize average ratings for all programs included in the proposal, while specifying a high live/non-live mix priority, indicating that the mix between live and non-live programs is important to the customer. In addition, other parameters may be specified to influence the generated proposals. For example, a customer may have a desire to have more college basketball advertising units. A user input field may be provided to specify that the generated proposal include a greater percentage of college basketball advertising units compared to previous purchases. A plurality of user influences may also be available to allow the user to view and edit the expressed or implied mix configuration (day-part mix 146, live mix 147, and the ratecard mix 148).

Once the user has entered all desired parameters, the user may click the save updates button 150. In response, the system saves the parameters, requirements, and settings. Once selected, the system may infer values for any unspecified parameters. In one embodiment, the inferred parameters may be presented to the user for approval before generating the proposals.

Generally, input for any parameter may be included in the GUI 100. For example, the GUI 100 may also include the selection of optimization templates. In one embodiment, optimization templates influence business rules used in the proposal generation, the mix of advertising inventory selected to include in a generated proposals, as well as eligible categories that can be used. For example, one plan template may limit the available categories of inventory to those previously purchased by the buyer, while another plan template may allow a specific new category that previous analysis identifies as desirable by the particular buyer.

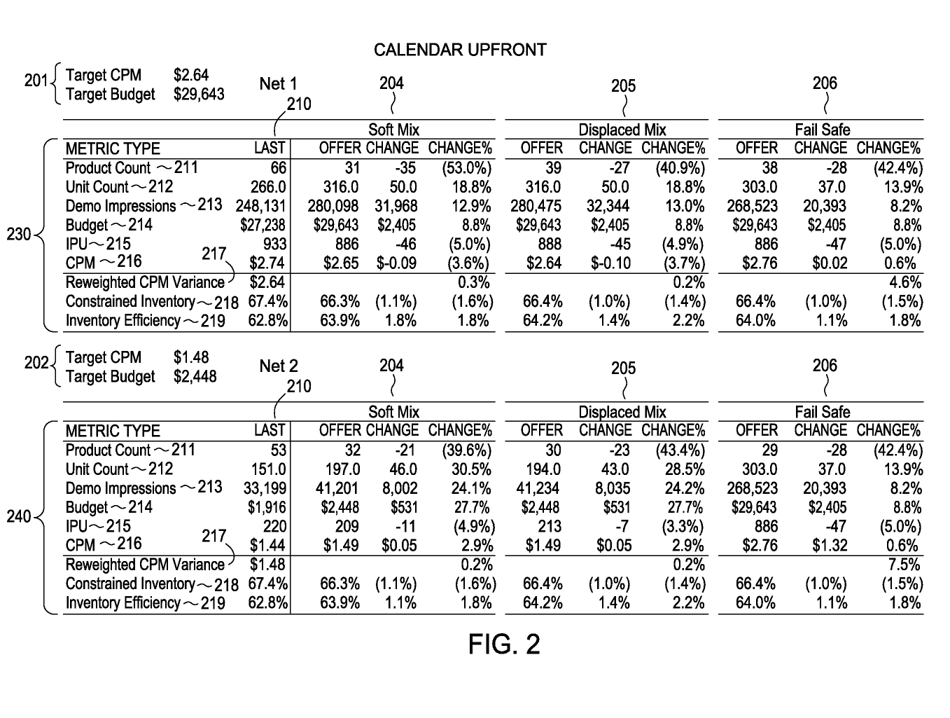

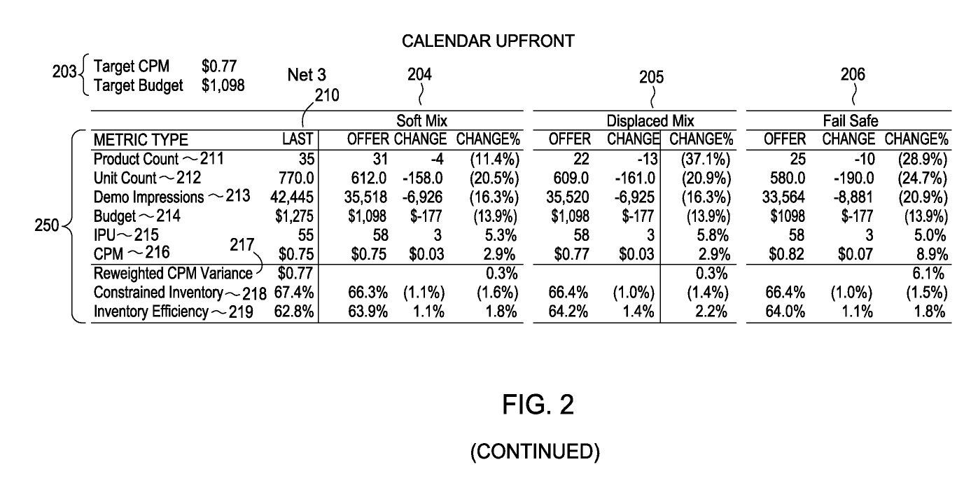

FIG. 2 illustrates an example of a summary of all proposals 200 generated using an embodiment of an ad sales proposal mix and pricing optimization. The proposal summary 200 includes multiple offer types. The proposal summary includes a soft mix 204, a displaced mix 205, and a failsafe mix 206 for three different example networks, namely Net1 201, Net2 202, and Net3 203. The results from each proposal optimization template are offer types 204-206. As shown, the proposal summary 200 includes all summarized key metrics to validate the resulting proposal(s) matches the defined input parameters. The embodiment includes a target CPM (cost per impression) and target budget for each network 201-203. For example, as shown, the target CPM for Net1 is $2.64, while the target budget (total dollars to be spent by the customer on Net1 advertisements) is $29,643. The proposal calendar 200 includes a table 230-250 for each network 201-203 specifying attributes of each proposal generated, and a last column 210, so the parties can compare the proposal values to previous proposal values.

As shown, each table 230-240 includes a product count 211 which specifies the total number of distinct products. A unit count 212 specifies the total number of units of the product in the proposal. A demo impressions 213 specifies a number of impressions in the target demographic. A budget 214 specifies the total budget under each proposal, while an IPU 215 specifies a total impressions per unit, and a CPM 216 specifies the total cost per impression. A reweighted CPM variance 217 specifies the variance in the total CPM versus the last CPM, while a constrained inventory percentage 218 indicates the percentage of constrained inventory in the proposal, and the inventory efficiency 219 specifies the efficiency of inventory included in the proposal.

Attributes 211-219 are specified for each network and for each offer type 204-206, and include a current value for the offer, a change against the last column 210, and a change percentage over the last column 210. For example, in table 230 for Net1, the product count 211 in the soft mix proposal for the customer includes 21 products, which is a decrease of 35 products over the 66 products in the last proposal, representing a decrease of 53%. The unit count 212 of the displaced mix 205 for NET1 in table 230 is 216, an increase of 50 units over the last unit count of 266, representing an 18.8% change. The failsafe mix 206 includes 268,523 impressions, a change of 20,393 over the last value of 248,131, or a change of 13.9%. In each mix 204-206 for NET1 in table 230, the budget 214 of $29,643 has been met. The impressions per unit 215 are relatively consistent at 886, 888, and 886, respectively, for mixes 204-206. The CPM 216 is $2.64 for soft mix 204, $26.42 for displaced mix 205, and $2.76 for failsafe mix 206, which meets or exceeds the target of $2.64 in each case. For NET1, in table 230, the reweighted CPM variance 217 is 0.3% for the soft mix 204, 0.2% for the displaced mix 205, and 4.6% for the failsafe mix 206. As shown, the amount of constrained inventory for each mix has decreased (66.3%, 66.4%, and 66.4%, respectively, for each offer type 204-206), which is beneficial because this inventory can be saved to close later deals with other customers, instead of using more constrained inventory on the current transaction. Finally, the efficiency of each proposal has increased to 63.9, 64.2%, and 64.0% respectively for each offer type 204-206.

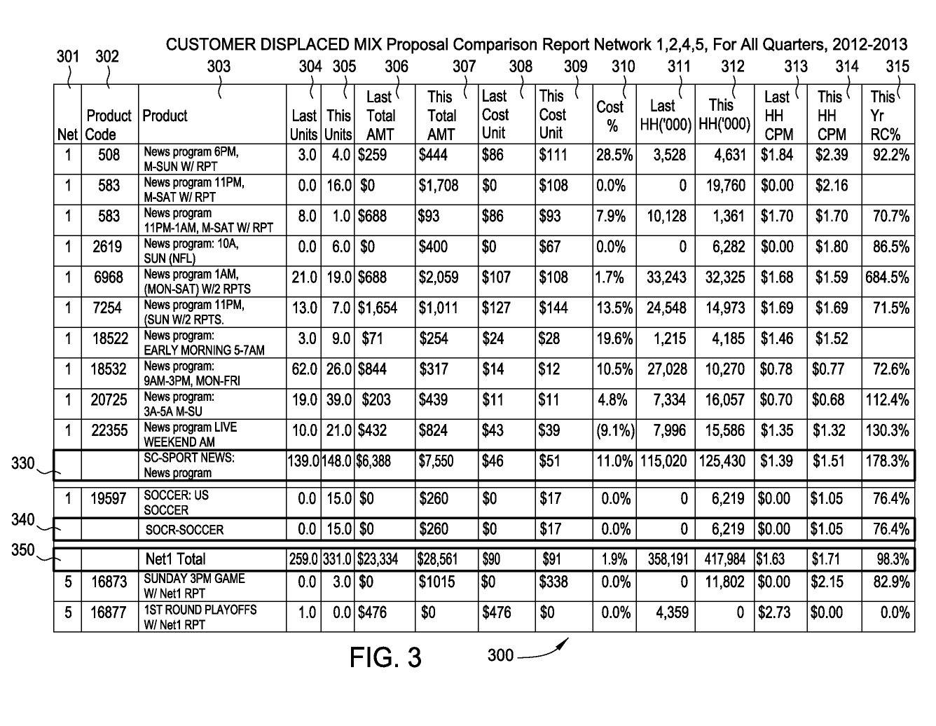

FIG. 3 illustrates a portion of a proposal 300 generated using sales proposal mix and pricing optimization, according to one embodiment. As shown, the proposal 300 is a displaced mix proposal for four networks for the year 2012-2013. The entire proposal, which may be hundreds of pages long, is not presented for the sake of simplicity. Each row of the proposal 300 is a line item specifying television programs with advertising inventory offered for sale as part of the advertising proposal. Net 301 specifies the network on which the advertising unit will air. A product code 302 identifies a particular program on the network 301, which is described in greater detail in selling rotation column 303. For example, selling rotation code 508 corresponds to the 6 PM airing of a News Program on Mondays through Sundays, with repeats.

A last units column 304 indicates a number of advertising units previously purchased during the program 303, while a units 305 column specifies the number of advertising units offered for sale in the current proposal. In the proposal 300, the customer had previously purchased three units of the 6 PM M-S News Program, while four units are currently offered for sale. A last total amount 306 indicates the amount previously spent by the customer on the selling rotation 303, while the total amount 307 indicates the current price for the number of units currently offered for sale. As shown, for the 6 PM M-S News Program, the customer previously paid $259, while the current price is $444. Last cost/unit 308 and the cost/unit 309 indicate the cost per unit previously spent and currently offered, respectively. As shown, the last cost per unit 308 for the 6 PM M-S News Program was $86, while the current cost per unit 309 is $111, which is a 28.5% increase, as reflected in cost % column 310. A last number of households (HH) (in thousands) reached by the selling rotation is shown in column 311, while the number of current households reached in the current plan is shown in column 312. As shown, for the 6 PM M-S News Program, 3,528 thousand households were previously reached, while 4,631 thousand households will be reached under the current proposal.

Column 313 specifies the previous proposal's household (HH) cost per impression (CPM), while column 314 specifies the current proposal's HH CPM, which are $1.84 and $2.39, respectively, for the 6 PM M-S News Program. A year ratecard % column 315 specifies the percentage of rack or list price for the particular units being purchased as part of the generated proposal 300.

As shown, the rows of the proposal 300 include a plurality of different airtimes for News Program. Advantageously, row 330 includes a total for all line items in the proposal 300 which are for some variant of News Program. Providing this summary allows parties to negotiations to determine the overall statistics for each television program, such as News Program. Rows 340 and 350 provide the same summary statistics for soccer, and the Net 1 network as a whole. Row 360 starts a new part of the proposal 300 dedicated to a different network, as indicated by the different value (5) in network column 301.

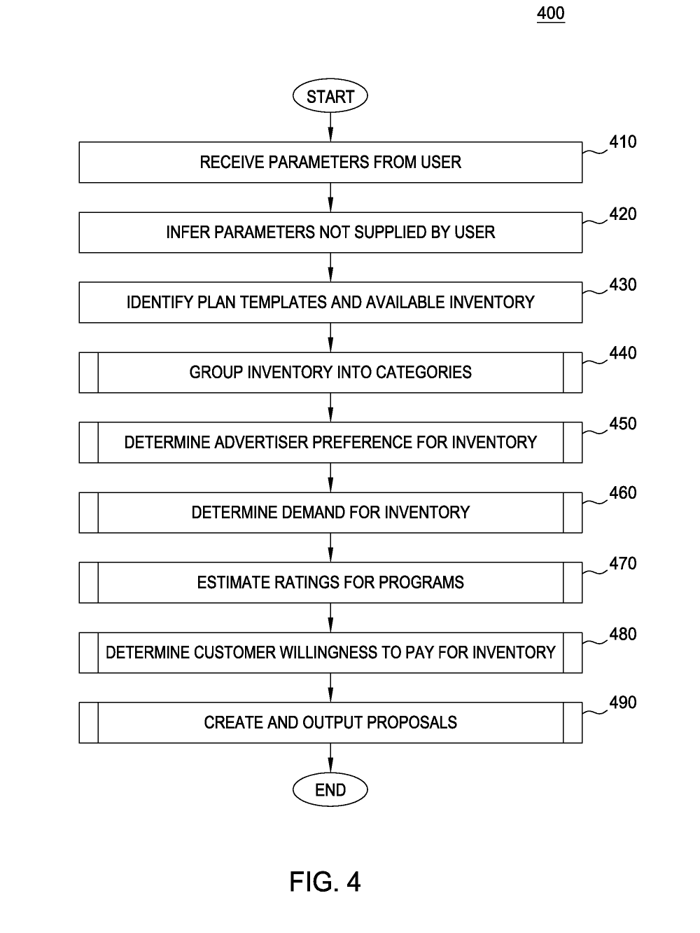

FIG. 4 illustrates a method 400 for sales proposal mix and pricing optimization, according to one embodiment. Generally, the steps of the method 400 allow a system to generate proposals including a mix (or a subset) of units of inventory and specifying a price for each of the subset of inventory and for the proposal as a whole. The method 400 allows the system to optimize the mix of inventory, as well as the offer price for each of the inventory units in the proposal. Doing so results in “sellable” plans by providing a sellable mix for the customer based on inventory clustering, customer preferences, inventory demand, inventory effectiveness or reach (e.g. TV program ratings), and customer willingness to pay. Although method 400 includes the steps of inventory clustering, customer preferences, inventory demand, inventory reach, and customer willingness to pay steps as being completed during execution of the program, in one embodiment, these steps may be preprocessed and their outputs saved as batch files used in generating a given proposal.

At step 410, the system receives parameters used to tailor a given proposal from the user. Examples of parameters include a target CPM, target budget, and date ranges for contract delivery. At step 420, the system infers parameters not supplied by the user to create an initial mixed distribution of different inventory (e.g. ratecard category, day part, live or studio status) preferences, for any given customer prior to generating optimized proposals. Generally, the software system may analyze historical proposals for a customer, and impute upper/lower target demographic impression percentage limits for highly desirable and less than desirable ratecard categories, day parts, and live broadcasting status prior to using the optimization tool. In one embodiment, results may be presented to the user prior to launching the optimization tool. Doing so allows the user to adjust any of the inferred (or implied) parameter values. In one embodiment, the system generates inferred parameters by segmenting all proposals into two categories, sports specific and non-sports specific. Sports specific proposals may be defined as any proposal which contains one sports specific ratecard category (such as football programming) with more than 98% of target demographics impressions assigned to it, or any sports specific ratecard category with greater than 50% of target demographics impressions and one non-sports specific ratecard category. Once the proposals are segmented, the most desirable ratecard categories, day part times, and live broadcasting status are identified for the customer. A set of historical unweighted mixed parameters may be generated at a first level, which includes the ratecard category, day part, and live broadcast status. A second level may identify, based on a first metric from the first level, the other two metric distributions from the first level. The resulting mixed parameters may be used as upper and lower thresholds for mixed parameters in the proposal optimization tool.

At step 430, the system may identify plan templates and available inventory. The plan templates may be specified by the user or selected by the system. For example, the user may specify to create a mirrored mix, which attempts to produce a proposal similar to the previous year's proposal. However, if the inventory from the previous proposal is not available, the software may generate proposals using other plan templates, such as a soft mix, displaced mix, or mirrored mix. A mirrored mix plan may result in a proposal which includes a mix of inventory “mirroring” a plan from previous years, but that is optimized to be more profitable to the seller for the current year. A displaced mix plan may introduce new categories of inventory not previously purchased by the customer. A soft mix plan may include the same categories of inventory previously purchased, but in different percentages per category compared to previous years. A fail safe mix template may cause the system to allocate the customer's budget in some way, which may typically be used when other criteria cannot be fulfilled (such as when inventory for a preferred category is sold out). The system may identify available inventory by referencing a database storing information related to all available inventory.

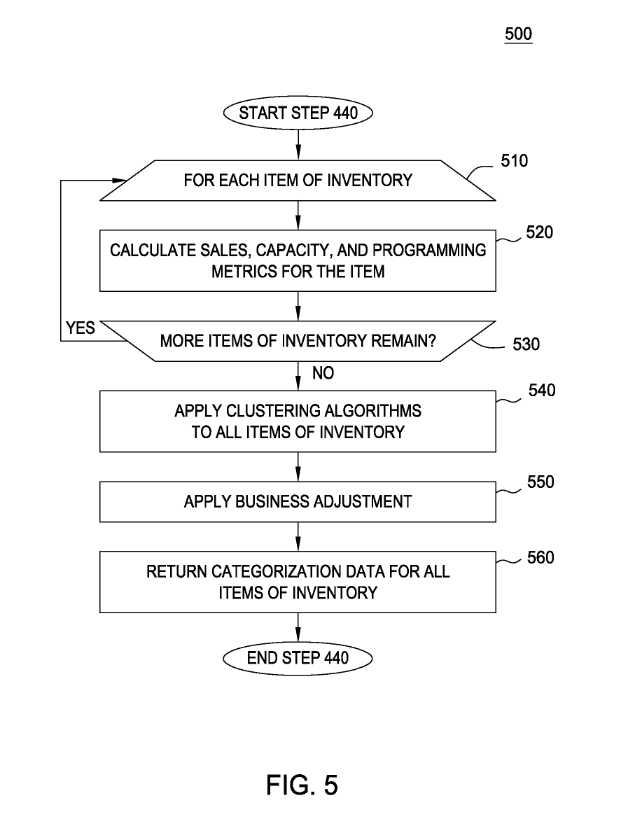

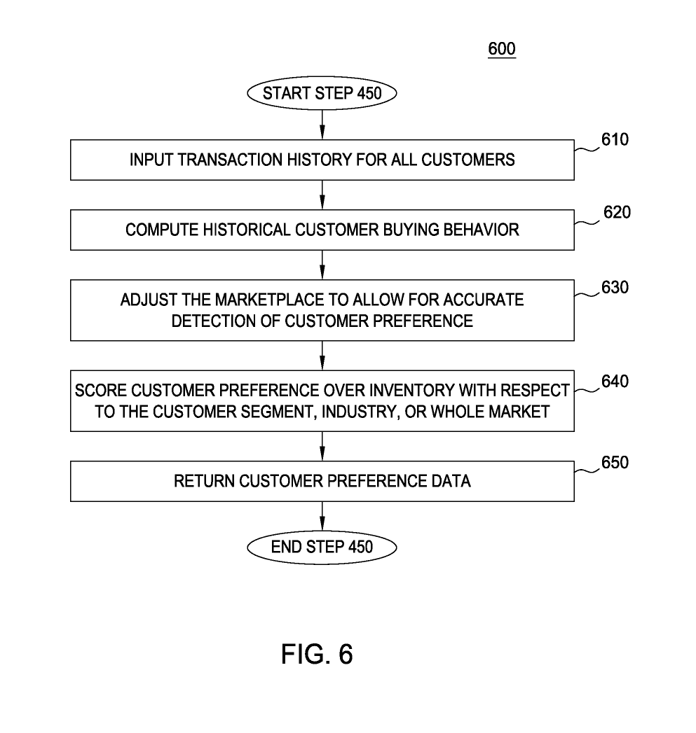

At step 440, described in greater detail with reference to FIG. 5, the system groups available inventory into categories. The categories may reflect a level of desirability of the inventory. For example, the most popular news program may be in a premium category along with the most popular sporting events aired by the network. At step 450, described in greater detail with reference to FIG. 6, the system determines preferences of the advertiser (or customer) for each type of inventory. In one embodiment, a clustering analysis may identify an overall quality of the inventory used to generate an offer. For example, if an advertiser has a preference (express or inferred, based on purchase history) for advertising during soccer games, it may be determined that the same advertiser has a preference for sports news programs related to soccer.

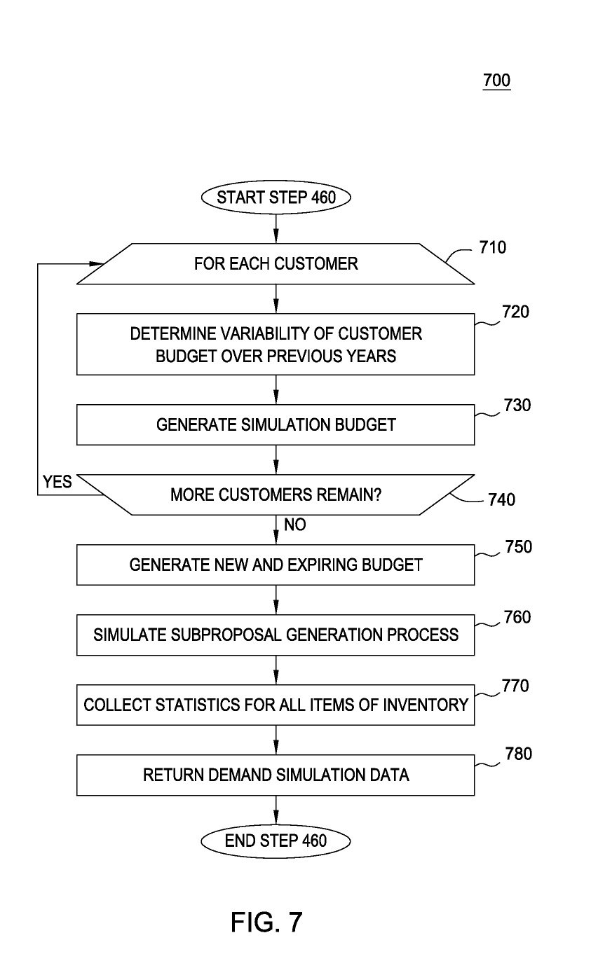

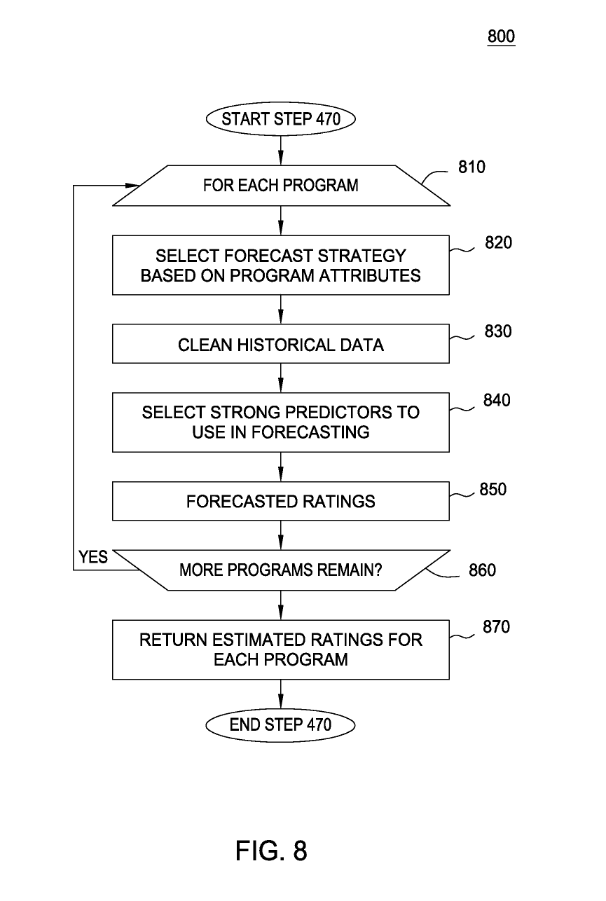

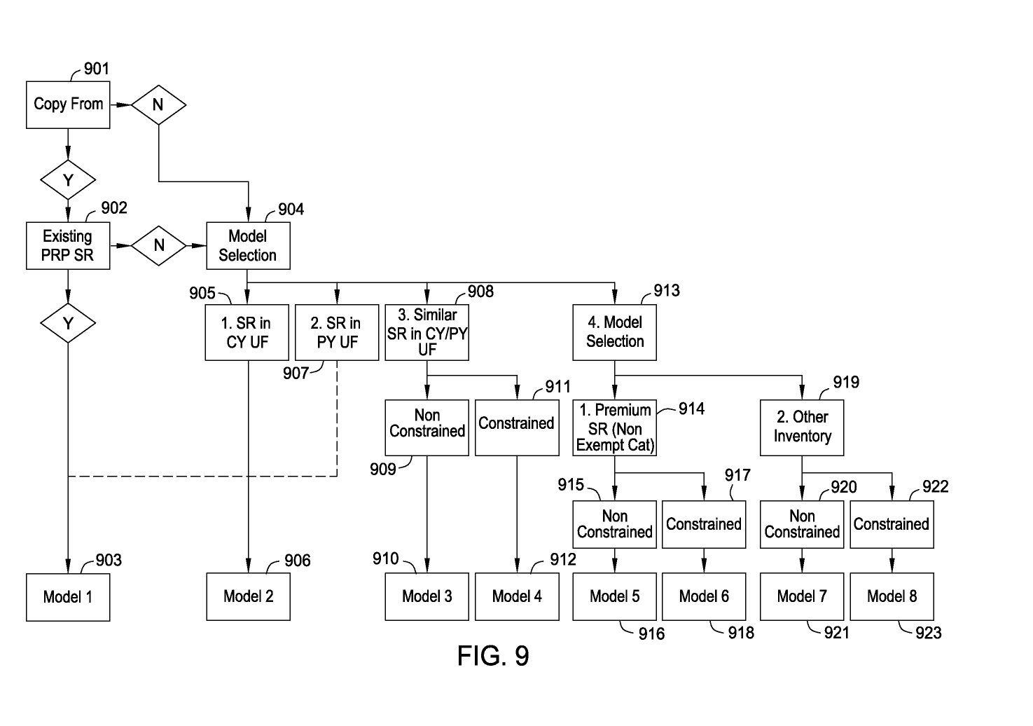

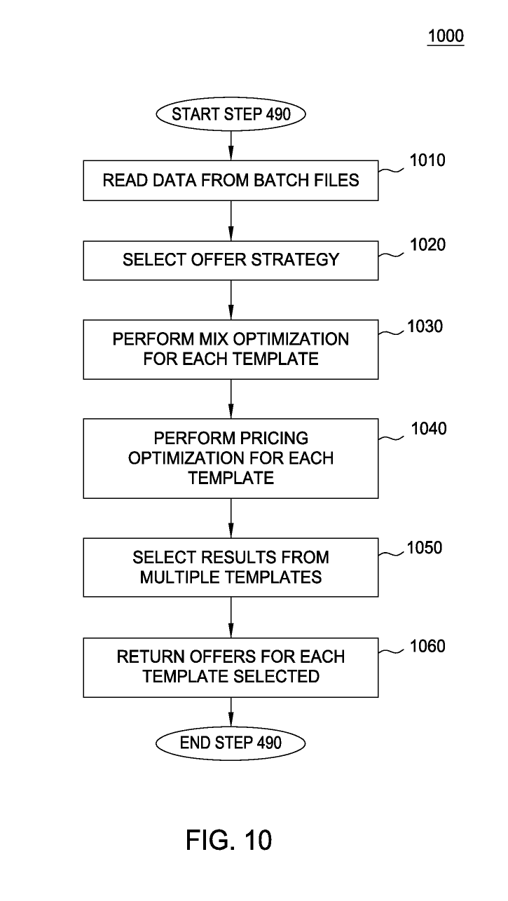

At step 460, described in greater detail with reference to FIG. 7, the system may determine a demand for all items of inventory. Demand for advertising inventory is very dynamic by nature, as customers have a propensity to shift inventory demands based on the timing and size of the deal and similarity of inventory attribution (e.g. similarity of sports categories, similar live status of programming, similarity of air times, similarity of pricing, similarity of delivery estimates). The system may determine demand by allocating an estimated budget to each advertiser/customer and allocating the estimated budget to a number of different items of advertising inventory. By running multiple simulations allocating the estimated budget, the system may determine which inventory (and which programs) are most likely to sell out, and therefore have the greatest demand. At step 470, described in greater detail with reference to FIG. 8, the system estimates ratings for each program. Generally, the system determines demand for each program based on either time series modeling for news programs or a fixed effect regression model for sporting events. At step 480, described in greater detail with reference to FIG. 9, the system determines a customer's willingness to pay for inventory. Generally, a pricing analysis is used to determine an acceptable range that be charged to a specific advertiser for a specific item of inventory. At step 490, described in greater detail with reference to FIG. 10, the system creates optimized proposals, which are then output to the user.

FIG. 5 illustrates a method 500 corresponding to step 440 to group inventory into categories, according to one embodiment. Generally, executing the method 500 allows the system to perform a clustering analysis to measure quality of inventory used to generate an offer by grouping the different types of advertising units into different categories. By applying the clustering analysis to the inventory of advertising units, an analytical grouping of selling rotations can be provided. For example, one possible output of the grouping may include the following categories: a super premium category (for example, championship games in sports leagues), a premium category (semi-final games in the sports leagues), a live-regular category (regular season games), a support-regular category (news programming related to sports), and a distressed inventory category (run of site inventory, secondary network support programming).

The system may also identify categories and input variables for the clustering analysis. The categories correspond to different clusters, or buckets, within which the inventory may belong. Any number of input variables may be defined as well. In one embodiment, sales metrics, capacity metrics, and programming attributes serve as high level variable categories each having a subset of corresponding variables.

At step 510, the system executes a loop including steps 520-530 for each item of advertising inventory. A database may store representations of the items of inventory, and may specify attributes including the input variables (express or inferred) as well as whether the inventory has been sold. At step 520, the system may calculate sales, capacity, and programming metrics for the item of advertising inventory. For example, the system may calculate the average price of the inventory and use it as a sales metric. The system may also calculate historical utilization of the inventory and use it as a capacity metric. The system may also analyze whether the advertising unit is aired during a live broadcast and use that as a programming metric. As a result, one item of advertising inventory may have a high unit price and a low price variance among multiple customers, enjoy a high utilization, and is delivered during a live, primetime sporting event for one of the most popular sports leagues. These highly favorable attributes may indicate that the item of advertising inventory belongs in a “super premium” category to be discussed with reference to step 550. At step 530, the software determines whether more items of advertising inventory remain to be analyzed. If so, the method returns to step 510.

Otherwise, at step 540, the system may apply a clustering algorithm to group all items of inventory into disjoint categories so that items in same category have similar sales, capacity, and programming attributes calculated in step 510-530. In one embodiment, k-means or Ward's clustering techniques may be used. At step 550, the system allows users to influence the raw science results to fine tune the output categories into buckets that are logical for business users. At step 560, the system returns categorization data for all items of inventory, which may be saved in a batch file for use by the proposal generation application.

FIG. 6 illustrates a method 600 corresponding to step 450 to determine advertiser preference for inventory, according to one embodiment. Generally, the method 600 allows the system to determine a customer's preference for all items of inventory, regardless of whether the customer has previously purchased similar Items of inventory. This determination may be based on expressed preferences, such as previous purchases or communications from the customer, as well as inferred preferences determined by the software. For example, if one auto maker previously purchased an advertising unit, the software may assume that other auto makers, may have a similar preference for advertising units. Alternatively, if a customer has a preference for one type of advertising unit, preference for a related advertising unit may be inferred. For example, if a customer consistently purchases advertising units during live football broadcasts, the customer may also prefer (or tolerate) purchasing advertising units during a football news program, even though they may not have purchased advertising units during the football news program in the past. In performing such an analysis, the preference of all items of advertising customer may be determined for all customers.

At step 610, the system receives transactional history for all customers. The transactional history may identify all items of inventory previously purchased by each customer. At step 620, the system may determine associations between different types of programming and advertising units using a combination of probability theory, statistical analysis, and graph theory algorithms. For example, if the transaction history reflects that customers purchase advertising units during both college basketball games and college basketball news programming at an 85% rate, the 85% frequency may indicate a strong association between college basketball games and the news programming. Stated differently, the frequency of joint purchases may indicate that the college basketball games and news programming bundle naturally together. Therefore, if a customer has historically only purchased advertising units during college basketball games, their preference for college basketball news programming may be increased and a proposal including the college basketball games and news programming may be generated. At step 630, the system compares customer purchasing metrics with market-level purchasing metrics to allow for accurate detection of customer preference. For example, if an average customer purchases a piece of inventory 50% of the time and one particular customer purchases the inventory 75% of the time, this indicates that this advertiser has a higher tendency to purchase than the average customer. At step 640, the system scores customer preference over the advertising inventory with respect to one or more of the customer segment, industry, or whole market. At step 650, the system may return customer preference data. In one embodiment, the customer preference data is stored in a batch file to enable real-time processing by the proposal generation application.

FIG. 7 illustrates a method 700 corresponding to step 460 to determine demand for inventory, according to one embodiment. Generally, in executing the method 700, the system identifies constrained inventory by generating simulated customer budgets, and generating a plurality of proposals (referred to as subproposals for clarity) that spend the simulated budgets on advertising inventory in some way. The subproposals may be generated using the same techniques that are used to generate proposals, in that they take customer preference, willingness to pay, inventory categorization, and ratings estimates into account. Once the subproposals are generated, the allocation of advertising units among the subproposals may be analyzed to determine what the simulated demand for the inventory is.

At step 710, the system executes a loop including steps 720-740 for each customer. At step 720, the system determines variability of the customer's budget by estimating how widely the customer changes its budget year over year on, for example, network quarterly level using budget data from previous years. At step 730, the system generates a simulation budget for the customer by running a number of simulations applying the variability to the high level of demand. At step 740, the system determines whether additional customers remain. If more customers remain, the method returns to step 710. Otherwise, the method proceeds to step 750, where the system generates new and expiring budget to simulate advertiser's tendency to purchase new networks/quarters or stop spending on existing networks/quarters. At step 760, the system may generate subproposals for all advertisers for each of the simulations runs based on the estimated budget. Generating the subproposals may allow the system to generate an association graph connecting a customer's demand to the advertising inventory. The association graph may reflect the demand, inventory offered for sale, constraints on inventory capacity, and the CPM for the inventory. At step 770, the system may determine the demand for the selling rotations in the subproposals based on a distribution of the selling rotations in the subproposals. For example, if all units of advertising inventory in the 6 PM News Program are sold out in 99% of the simulation runs, it is probable that the 6 PM News Program will sell out in real negotiations. In addition to computing a probability that the selling rotation will sell out, many other attributes may be computed, including but not limited to expected value of each customer's purchase and the effect of adding or removing selling rotations. At step 780, the system returns the demand simulation data. In one embodiment, the demand simulation data is saved to a batch file to enable real-time processing by the proposal generation application.

FIG. 8 illustrates a method 800 corresponding to step 470 to estimate ratings for programs, according to one embodiment. Generally, the method 800 provides a common modeling approach to predict ratings for news and sports programming.

At step 810, the system executes a loop including steps 820-870 for each program for which advertising units are sold. At step 820, the system identifies the type of program, which may be a news program or a sporting event, and selects a forecasting strategy accordingly. News programs may be based on a time series modeling, while a fixed effect regression modeling may be applied to matchups and sporting events. For news programs, which are generally aired daily, time series models may be used. This technique models level, trends, and seasonality components with specified parameters. For sporting events, the ratings may be determined on a per-event basis using the fixed effect regression. The regression approach may take game statistics, team statistics, and player data as inputs. At step 830, the system cleans historical data by detecting outliers, missing values, and information incompatible with sports event nature and television rating systems.

At step 840, the system identifies strong predictors for forecasting ratings. For example, for a live basketball game, the rating may be driven by the home and away teams and the number of social media posts for each player. By identifying the strength for these predictors, the rating of the event may be more accurately forecasted. At step 850, the system calculates forecasted ratings for the program. In one embodiment, a plurality of models are generated to forecast ratings of the same program, and the best-performing models are identified and kept.

At step 860, if more programs need to have their ratings forecasted, the method returns to step 810. If no more programs remain, the method proceeds to step 870, where the estimated ratings for each program are returned. In one embodiment, the estimated ratings are saved to a batch file to enable real-time processing by the proposal generation application.

FIG. 9 illustrates a decision tree 900 used to determine customer willingness to pay for inventory, according to one embodiment. Generally, the system uses decision tree 900 to select a pricing plan for a given selling rotation based on a number of criteria. For example, the system may use the decision tree to generate recommended pricing estimates for fluctuating inventory levels and recommended price minimums may be set at a customer segment level. Customer segments eligible for reserved inventory may also be identified, allowing for elasticity estimates per customer segment. The price ranges may be made for an individual item of inventory as well as for an entire proposal.

The decision tree may include a variety of pricing models. As shown, the decision tree 900 includes eight different pricing models. Model 1 applies a year over year target increase over the previous year price for the selling rotation using advertiser-level data. A multi-year increase may be applied if the previous proposal is greater than one year old. Model 2 applies the same price as the current market (e.g. upfront). Model 3 specifies to derive a range from similar selling rotations in the current year and previous year plans, with their prices adjusted for year over year increases. The exact price selected from the range may be based on ratings, demand, and market conditions. Model 4 uses model 3 as a base, but also sets a minimum price at the displacement cost plus a variable percentage increase. Model 5 uses an agency level model if historical data is not sufficient to support an advertiser level model for the current selling rotation. This can happen when the agency has no other client besides the current advertiser. A hierarchy may be defined, for example, by searching first advertiser level models, then agency level models, then industry level models, and finally market level models. Model 6 uses model 5 as a base and sets a minimum price at the displacement cost plus a variable percentage increase. Model 7 uses product category level models if the historical inventory is not similar to the current selling rotation. A hierarchy may be used at a selling rotation level—if this is not feasible, a hierarchy for the selling rotation category may be used—if this is still not feasible, a ratecard category model percentage model is used. Model 8 uses model 7 as a base, but sets a minimum price at the displacement cost plus a variable percentage increase.

At node 901 of the decision tree, the system determines whether to use an existing proposal as the basis for the pricing model. If yes, at node 902, the system determines whether the selling rotation was bought in the base proposal. If the selling rotation was bought, then pricing model 1 is applied at node 903. If a pricing plan is not copied at node 901, or an existing proposal for the selling rotation is not used at node 902, then at node 904, a pricing model selection occurs at nodes 905, 907, 908, and 913. If at node 905, the selling rotation was bought very recently (e.g., in the same upfront market in the current season), then model 2 is applied at node 906 in order to apply the newest pricing information. If at node 907, the selling rotation in the previous year is upfront (UF), then model 1 is applied. If, at node 908, a similar selling rotation in the current year or previous year upfront is identified, the system determines whether the inventory is constrained or nonconstrained. If the inventory is nonconstrained at node 909, model 3 is applied at node 910. If the inventory is constrained, then model 4 is applied at node 912. At node 913, the system determines whether the inventory is premium inventory (node 914), or some other of category of inventory (node 919). If the inventory is premium, the system determines whether the inventory is nonconstrained (node 915) or constrained (node 917). If the inventory is nonconstrained, then pricing model 5 is applied at node 916. If the inventory is constrained, then pricing model 6 is applied at node 918. If the inventory is other inventory at node 919, the system again determines whether the inventory is nonconstrained (node 920) or constrained (node 922). If the inventory is nonconstrained, then pricing model 7 may be applied at step 921. If the inventory is constrained, then pricing model 8 may be applied at node 923.

FIG. 10 illustrates a method 1000 to create and output proposals, according to one embodiment. Generally, the method 1000 allows the system to leverage customer preferences, inventory categorization, willingness to pay, ratings estimates, and demand simulation in generating advertising proposals for each of one or more plan templates.

At step 1010, the system reads all customer and inventory information, including customer preferences, inventory categorization, willingness to pay, ratings estimates, and demand simulation from the batch files. In another embodiment, the system receives the data in real time. At step 1020, the system selects an offer strategy based on advertiser information and market conditions. A strategy may include multiple offers optimized for different objectives while satisfying advertiser and firm needs. For each offer affiliated with the strategy, the system performs mix optimization and pricing optimization in parallel, at steps 1040-1050. In particular, at step 1040, the system generates a mix of advertising inventory units based on the customer preferences, inventory categorization, willingness to pay, ratings estimates, and demand simulation. The optimized mix is generated using general pricing ranges of each item of inventory. The resulting inventory mix reserves high demand, premium inventory for future deals and improves the overall demographic utilization within the inventory mix. At step 1050, the system generates an optimal itemized price for each item in the proposal. The pricing optimization helps ensure that the line item totals for each item in the proposal equals the total budget for the customer and that the target CPM is met. At step 1060, the system compares multiple offers and selects the best ones before the system returns proposals for each plan template at step 1070.

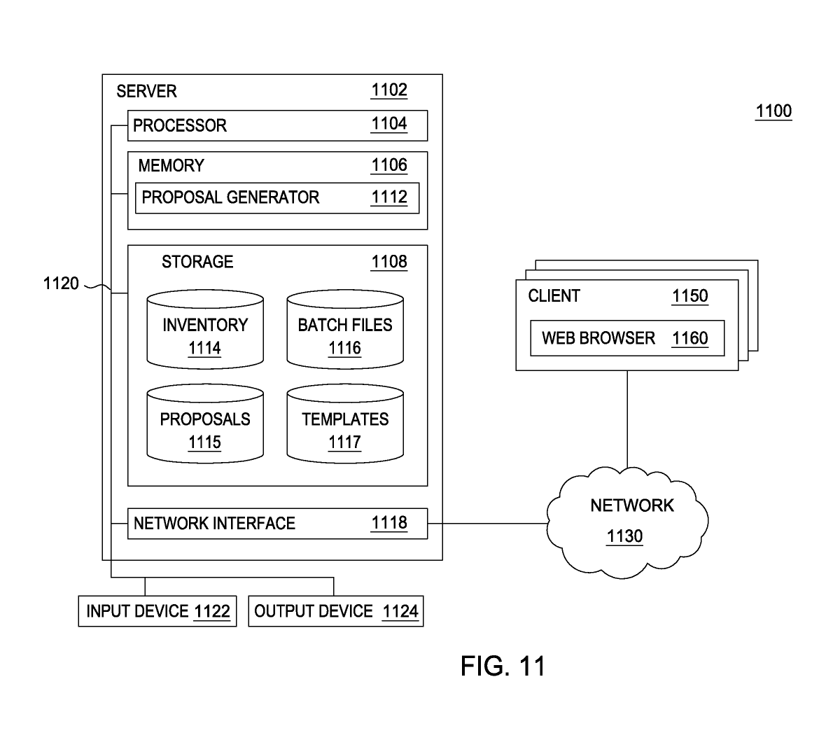

FIG. 11 illustrates a system 1100 for sales proposal mix and pricing optimization, according to one embodiment disclosed herein. The networked system 1100 includes a computer 1102. The computer 1102 may also be connected to other computers via a network 1130. In general, the network 1130 may be a telecommunications network or a wide area network (WAN). In a particular embodiment, the network 1130 is the Internet.

The computer 1102 generally includes a processor 1104 connected via a bus 1120 to a memory 1106, a network interface device 1118, a storage 1108, an input device 1122, and an output device 1124. The computer 1102 is generally under the control of an operating system (not shown). The processor 1104 is included to be representative of a single CPU, multiple CPUs, a single CPU having multiple processing cores, and the like. Similarly, the memory 1106 may be a random access memory. The network interface device 1118 may be any type of network communications device allowing the computer 1102 to communicate with other computers via the network 1130.

The storage 1108 may be a persistent storage device. Although the storage 1108 is shown as a single unit, the storage 1108 may be a combination of fixed and/or removable storage devices, such as fixed disc drives, solid state drives, removable memory cards or optical storage. The memory 1106 and the storage 1108 may be part of one virtual address space spanning multiple primary and secondary storage devices.

The input device 1122 may be any device for providing input to the computer 1102. For example, a keyboard or a mouse may be used. The output device 1124 may be any device for providing output to a user of the computer 1102. For example, the output device 1124 may be any conventional display screen or set of speakers. Although shown separately from the input device 1122, the output device 1124 and input device 1122 may be combined. For example, a display screen with an integrated touch-screen may be used.

As shown, the memory 1106 contains the proposal generator 1112, which is an application generally configured to generate an itemized sales proposal containing an optimized mix of inventory at an optimized price. The proposal generator 1112, in generating the optimized proposals, may determine customer preferences, bundle items of inventory into a plurality of different categories, identify a customer's willingness to pay for inventory, estimate ratings for specific programs, and simulate demand for the inventory. The proposal generator 1112 may generate multiple proposals, one for each type of optimization template selected by either the system or a user. As shown, a plurality of client computers 1150 may access the proposal generator 1112 using a web browser 1160, or other similar frontend interface.

As shown, the storage 1108 includes an inventory 1114, which stores data related to advertising inventory that is the subject of the proposals generated by the proposal generator 1112. In addition to storing records for each item of inventory, attributes of the inventory may be defined, which may include, but is not limited to whether the inventory has been sold, specific details about the participants of a live sporting event, ratings information, day/time information, whether the inventory is to be aired during a live or taped program, and the like. The storage 1108 also includes a proposals 1115, which is used to store new proposals generated by the proposal generator 1112, as well as serve as an archive for historical proposals. The data stored in the proposals 1115 may include line items details, proposal summaries, mix summaries, and any type of attribute for the generated proposals. The storage 1108 also includes the batch files 1116, which may be the output of the proposal generator 1112. In one embodiment, designated components of the proposal generator 1112 may periodically execute to output batch files related to inventory clustering, customer preferences, inventory demand, program ratings, and customer willingness to pay, which are then stored in the batch files 1116 for retrieval by the proposal generator 1112 while generating proposals.

As shown, the storage 1108 also includes optimization templates 1117, which generally includes different rules for the optimization while generating proposals. For example, a mirror mix template may be stored to indicate each customer's previous proposals, including the mix of advertising units and corresponding prices. Generally, any type of template may be stored in the templates 1117. Although depicted as databases, any suitable data structure may be used to store the data of the inventory 1114, the proposals 1115, the batch files 1116, and the templates 1117. Although depicted as residing on the same computer, the proposal generator 1112, the inventory 1114, the proposals 1115, the batch files 1116, and the templates 1117 may reside on any number of different physical or virtual machines.

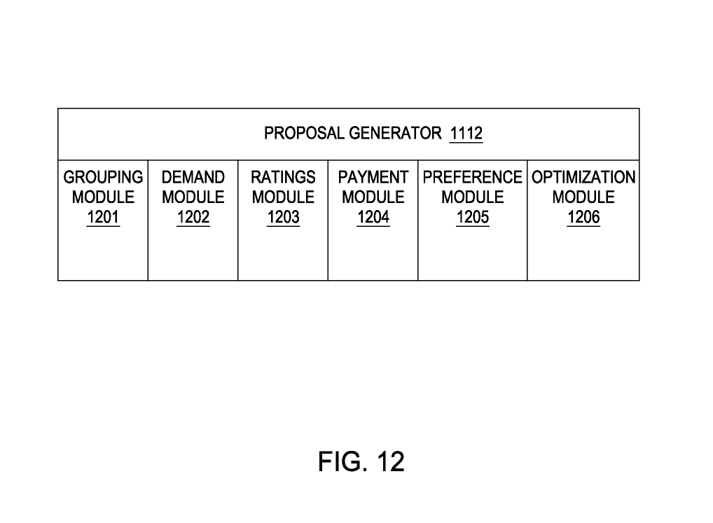

FIG. 12 illustrates components 1200 of the proposal generator application 1112, according to one embodiment disclosed herein. As shown, the proposal generator application 1112 includes a grouping module 1201, a demand module 1202, a ratings module 1203, a payment module 1204, a preference module 1205, and an optimization module 1206. The grouping module 1201 may be configured to group items of advertising inventory into different categories based on the quality of the inventory as determined by the clustering analysis of the method 500. The demand module 1202 may be configured to calculate a demand for inventory based on the techniques described in the method 700. The ratings module 1203 may estimate ratings for different programs, including live sporting events, using attributes of the sporting events, such as the teams and the players involved, as described above in greater detail with reference to FIG. 8. A payment module 1204 may calculate, for any given customer, the customer's willingness to pay for a specific selling rotation, as described in greater detail above with reference to FIG. 9. The willingness to pay analysis provides an acceptable range that may be charged to the customer. The preferences module 1205 determines customer preferences for each item of advertising inventory based on the techniques described in greater detail above with reference to FIG. 6.

Advantageously, embodiments disclosed herein use customer preferences, inventory categorization, willingness to pay, ratings estimates, and demand simulation in generating advertising proposals for multiple plan templates. The plan template may supply optimization parameters and business rules to ensure the mix of the proposal is acceptable to the buyer. Embodiments disclosed herein allow users to enter values for some parameters, and will infer values for the remaining parameters. In addition, embodiments disclosed herein provide for a final pricing adjustment based on the overall mix that allows the system to reoptimize if the mix is identified as premium.

In the foregoing, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and block diagrams of methods, apparatus (systems) and computer program products according to embodiments of the disclosure. It will be understood that each block of the flowchart illustrations and block diagrams, and combinations of blocks in the flowchart illustrations and block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and block diagram block or blocks.

Embodiments of the disclosure may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present disclosure, a user may access an application to generate advertising proposals or related data available in the cloud. For example, the application to generate advertising proposals could execute on a computing system in the cloud and generate a plurality of advertising proposals for specific customers. In such a case, the application could generate the proposals and store the generated proposals at a storage location in the cloud. Doing so allows a user to access this information from any computing system attached to a network connected to the cloud (e.g., the Internet).

While the foregoing is directed to embodiments of the present disclosure, other and further embodiments of the disclosure may be devised without departing from the basic scope thereof, and the scope thereof is determined by the claims that follow.

What is claimed is:

1. A method to generate a sales proposal including a subset of items of inventory from a plurality of items of inventory, comprising:
determining, for a customer, a level of preference for each of a plurality of items of inventory;
classifying each item of inventory into one of a plurality of categories;
determining, for the customer, a price range for each item of inventory;
computing a demand for each of a plurality of items of media content;
selecting a subset of the items of advertising inventory based on: (i) the demand for each of a plurality of programs, (ii) the level of preference for each of the plurality of items of inventory, and (iii) the classification of each of the plurality of items of inventory; and
computing, by operation of one or more computer processors: (i) a total cost for the proposal, and (ii) a cost for each item of inventory in the subset.

2. The method of claim 1, wherein each of the plurality of items of inventory is associated with at least one item of media content, wherein computing the respective demand for each of the plurality of items of media content comprises:
forecasting, for the customer, a high level budget based on at least one historical advertising plan for each respective customer, the at least one historical advertising plan comprising a total budget and a plurality of items of media content for which at least one item of inventory was purchased;
determining a variability for the high level budget for each customer;
executing one or more simulations applying the variability to the high level budget to generate an estimated budget for each customer;
generating a one or more subproposals allocating the estimated budget to each of the plurality of items of media content for which at least one item of inventory was purchased in the historical advertising plan; and
calculating the demand for each of the plurality of items of media content based on the generated plurality of subproposals.

3. The method of claim 1, wherein the at least one proposal is further based on an optimization template specifying at least one set of optimization parameters, wherein the optimization parameters comprise at least one of: (i) a previous purchase history of the customer, (ii) introducing at least one category of inventory not included in the previous purchase history, (iii) introducing a different mix between a set of categories of inventory in the previous purchase history, and (iv) allocating the purchasing budget to available inventory.

4. The method of claim 1, wherein the items of media content comprise video broadcasts, the method further comprising determining a ratings estimate for each of the plurality of items of media content, wherein determining the ratings estimate for each of the plurality of items of media content comprises:
applying a time series model to each of the plurality of items of media content that are not live sporting events; and
applying a fixed effect regression model to each of the plurality of items of media content that are live sporting events, wherein the fixed effect regression model estimates ratings for each live sporting event based on at least one of: (i) a historical performance of each team participating in the live sporting event, (ii) a size of a fan base of each team participating in the live sporting event, (iii) a home team of the live sporting event, (iv) an away team of the live sporting event, (v) a winning percentage of each team participating in the live sporting event, (vi) a number of impressions on the respective websites of each team participating in the live sporting event, (vii) a popularity of at least one player of each team participating in the live sporting event, (viii) a statistical performance of at least one player of each team participating in the live sporting event, and (ix) a number of all star votes received by at least one player of each team participating in the live sporting event.

5. The method of claim 1, wherein the items of media content comprise video broadcasts, wherein classifying each item of inventory is based on at least one of: (i) a cost per unit of each item of inventory, (ii) a household cost per impression (CPM) of each item of inventory, (iii) a variance of the household CPM, (iv) a sales ratings estimate of each item of inventory, (v) a total inventory capacity, (vi) a historical utilization of the total inventory capacity, and (vii) one or more attributes of an item of content during which each item of inventory is broadcasted.

6. The method of claim 1, wherein the price range for the items of inventory is based on at least one of: (i) a price previously paid for a similar item of inventory, (ii) the customer, (iii) a network on which the item of inventory is to be broadcast, (iv) a variability in prices previously paid for similar items of inventory, (v) one or more market conditions, (vi) a price paid by a competitor of the customer for the item of inventory or similar items of inventory, and (vi) an advertising agency representing the customer.

7. The method of claim 1, wherein the at least one advertising proposal is generated to include a minimum number of items of inventory that have been classified as belonging to a premium category of inventory.

8. The method of claim 1, wherein the level of preference of the customer for each of a plurality of items of inventory based on at least one of: (i) one or more historical items of inventory purchased by the customer, (ii) one or more historical items of inventory purchased by a second customer, wherein the second customer is in a same industry as the customer, (iii) a relationship between a first item of inventory and a second item of inventory, (iv) a number of times the first item of inventory and the second item of inventory have been purchased together, and (v) one or more explicit preferences specified for the customer.

9. A computer program product to generate a sales proposal, the computer program product comprising:
a computer-readable storage medium having computer-readable program code embodied therewith, the computer-readable program code comprising:
computer-readable program code configured to determine, for a customer, a level of preference for each of a plurality of items of inventory;
computer-readable program code configured to classify each item of inventory into one of a plurality of categories;
computer-readable program code configured to determine, for the customer, a price range for each item of inventory;
computer-readable program code configured to compute a demand for each of a plurality of items of media content;
computer-readable program code configured to select a subset of the items of advertising inventory based on: (i) the demand for each of a plurality of programs, (ii) the level of preference for each of the plurality of items of inventory, and (iii) the classification of each of the plurality of items of inventory; and
computer-readable program code configured to compute: (i) a total cost for the proposal, and (ii) a cost for each item of inventory in the subset.

10. The computer program product of claim 9, wherein each of the plurality of items of inventory is associated with at least one item of media content, wherein computing the respective demand for each of the plurality of items of media content comprises:
forecasting, for the customer, a high level budget based on at least one historical advertising plan for each respective customer, the at least one historical advertising plan comprising a total budget and a plurality of items of media content for which at least one item of inventory was purchased;
determining a variability for the high level budget for each customer;
executing one or more simulations applying the variability to the high level budget to generate an estimated budget for each customer;
generating a one or more subproposals allocating the estimated budget to each of the plurality of items of media content for which at least one item of inventory was purchased in the historical advertising plan; and
calculating the demand for each of the plurality of items of media content based on the generated plurality of subproposals.

11. The computer program product of claim 9, wherein the at least one proposal is further based on an optimization template specifying at least one set of optimization parameters, wherein the optimization parameters comprise at least one of: (i) a previous purchase history of the customer, (ii) introducing at least one category of inventory not included in the previous purchase history, (iii) introducing a different mix between a set of categories of inventory in the previous purchase history, and (iv) allocating the purchasing budget to available inventory.

12. The computer program product of claim 9, wherein the items of media content comprise video broadcasts, the computer-readable program code further comprising determining a ratings estimate for each of the plurality of items of media content, wherein determining the ratings estimate for each of the plurality of items of media content comprises:
applying a time series model to each of the plurality of items of media content that are not live sporting events; and
applying a fixed effect regression model to each of the plurality of items of media content that are live sporting events, wherein the fixed effect regression model estimates ratings for each live sporting event based on at least one of: (i) a historical performance of each team participating in the live sporting event, (ii) a size of a fan base of each team participating in the live sporting event, (iii) a home team of the live sporting event, (iv) an away team of the live sporting event, (v) a winning percentage of each team participating in the live sporting event, (vi) a number of impressions on the respective websites of each team participating in the live sporting event, (vii) a popularity of at least one player of each team participating in the live sporting event, (viii) a statistical performance of at least one player of each team participating in the live sporting event, and (ix) a number of all star votes received by at least one player of each team participating in the live sporting event.

13. The computer program product of claim 9, wherein the items of media content comprise video broadcasts, wherein classifying each item of inventory is based on at least one of: (i) a cost per unit of each item of inventory, (ii) a household cost per impression (CPM) of each item of inventory, (iii) a variance of the household CPM, (iv) a sales ratings estimate of each item of inventory, (v) a total inventory capacity, (vi) a historical utilization of the total inventory capacity, and (vii) one or more attributes of an item of content during which each item of inventory is broadcasted.

14. The computer program product of claim 9, wherein the price range for the items of inventory is based on at least one of: (i) a price previously paid for a similar item of inventory, (ii) the customer, (iii) a network on which the item of inventory is to be broadcast, (iv) a variability in prices previously paid for similar items of inventory, (v) one or more market conditions, (vi) a price paid by a competitor of the customer for the item of inventory or similar items of inventory, and (vi) an advertising agency representing the customer.

15. The computer program product of claim 9, wherein the at least one advertising proposal is generated to include a minimum number of items of inventory that have been classified as belonging to a premium category of inventory.

16. The computer program product of claim 9, wherein the level of preference of the customer for each of a plurality of items of inventory based on at least one of: (i) one or more historical items of inventory purchased by the customer, (ii) one or more historical items of inventory purchased by a second customer, wherein the second customer is in a same industry as the customer, (iii) a relationship between a first item of inventory and a second item of inventory, (iv) a number of times the first item of inventory and the second item of inventory have been purchased together, and (v) one or more explicit preferences specified for the customer.

17. A system, comprising:
one or more computer processors; and
a memory containing a program which when executed by the one or more computer processors performs an operation to generate a sales proposal, the operation comprising:
determining, for a customer, a level of preference for each of a plurality of items of inventory;
classifying each item of inventory into one of a plurality of categories;
determining, for the customer, a price range for each item of inventory;
computing a demand for each of a plurality of items of media content;
selecting a subset of the items of advertising inventory based on: (i) the demand for each of a plurality of programs, (ii) the level of preference for each of the plurality of items of inventory, and (iii) the classification of each of the plurality of items of inventory; and
computing: (i) a total cost for the proposal, and (ii) a cost for each item of inventory in the subset.

18. The system of claim 17, wherein each of the plurality of items of inventory is associated with at least one item of media content, wherein computing the respective demand for each of the plurality of items of media content comprises:
forecasting, for the customer, a high level budget based on at least one historical advertising plan for each respective customer, the at least one historical advertising plan comprising a total budget and a plurality of items of media content for which at least one item of inventory was purchased;
determining a variability for the high level budget for each customer;
executing one or more simulations applying the variability to the high level budget to generate an estimated budget for each customer;
generating a one or more subproposals allocating the estimated budget to each of the plurality of items of media content for which at least one item of inventory was purchased in the historical advertising plan; and
calculating the demand for each of the plurality of items of media content based on the generated plurality of subproposals.

19. The system of claim 17, wherein the at least one proposal is further based on an optimization template specifying at least one set of optimization parameters, wherein the optimization parameters comprise at least one of: (i) a previous purchase history of the customer, (ii) introducing at least one category of inventory not included in the previous purchase history, (iii) introducing a different mix between a set of categories of inventory in the previous purchase history, and (iv) allocating the purchasing budget to available inventory.

20. The system of claim 17, wherein the items of media content comprise video broadcasts, the operation further comprising determining a ratings estimate for each of the plurality of items of media content, wherein determining the ratings estimate for each of the plurality of items of media content comprises:
applying a time series model to each of the plurality of items of media content that are not live sporting events; and
applying a fixed effect regression model to each of the plurality of items of media content that are live sporting events, wherein the fixed effect regression model estimates ratings for each live sporting event based on at least one of: (i) a historical performance of each team participating in the live sporting event, (ii) a size of a fan base of each team participating in the live sporting event, (iii) a home team of the live sporting event, (iv) an away team of the live sporting event, (v) a winning percentage of each team participating in the live sporting event, (vi) a number of impressions on the respective websites of each team participating in the live sporting event, (vii) a popularity of at least one player of each team participating in the live sporting event, (viii) a statistical performance of at least one player of each team participating in the live sporting event, and (ix) a number of all star votes received by at least one player of each team participating in the live sporting event.

21. The system of claim 17, wherein the items of media content comprise video broadcasts, wherein classifying each item of inventory is based on at least one of: (i) a cost per unit of each item of inventory, (ii) a household cost per impression (CPM) of each item of inventory, (iii) a variance of the household CPM, (iv) a sales ratings estimate of each item of inventory, (v) a total inventory capacity, (vi) a historical utilization of the total inventory capacity, and (vii) one or more attributes of an item of content during which each item of inventory is broadcasted.

22. The system of claim 17, wherein the price range for the items of inventory is based on at least one of: (i) a price previously paid for a similar item of inventory, (ii) the customer, (iii) a network on which the item of inventory is to be broadcast, (iv) a variability in prices previously paid for similar items of inventory, (v) one or more market conditions, (vi) a price paid by a competitor of the customer for the item of inventory or similar items of inventory, and (vi) an advertising agency representing the customer.

23. The system of claim 17, wherein the at least one advertising proposal is generated to include a minimum number of items of inventory that have been classified as belonging to a premium category of inventory.

24. The system of claim 17, wherein the level of preference of the customer for each of a plurality of items of inventory based on at least one of: (i) one or more historical items of inventory purchased by the customer, (ii) one or more historical items of inventory purchased by a second customer, wherein the second customer is in a same industry as the customer, (iii) a relationship between a first item of inventory and a second item of inventory, (iv) a number of times the first item of inventory and the second item of inventory have been purchased together, and (v) one or more explicit preferences specified for the customer.
